(19) United States
(12) Patent Application Publication
(10) Pub. No.: US 2004/0007624 A1
(43) Pub. Date: Jan. 15, 2004

(54) Medium processing apparatus

(76) Inventors: Hiroshi Ogawa, Kyoto (JP); Masato Nishikawa, Kyoto (JP); Yutaka Machida, Kyoto (JP); Shozo Fuwa, Kyoto (JP)

Correspondence Address: Dickstein Shapiro, Morin & Oshinsky, 2101 L Street NW, Washington, DC, 20037-1526, US

(21) Appl. No.: 10/297,428

(22) PCT Filed: Jun. 13, 2001
(86) PCT No.: PCT/JP01/05047

(30) Foreign Application Priority Data
Jun. 15, 2000 (JP) 2000-180011

(51) Int. Cl. G06K 13/00

(52) U.S. Cl. 235/475

(57) ABSTRACT

A medium processing apparatus comprising a traveling bucket having a medium receiving opening inside and a medium ejecting opening outside and movable from a medium receiving position to a medium ejecting position and reversible transfer means for permitting the traveling bucket to travel while oriented in one traveling direction or in the reverse traveling direction.

Technical Field

This invention relates to a medium processing apparatus as is applied to, for example, an automated teller machine (ATM) installed in a banking organ, and more particularly to a medium processing apparatus which includes a processing mechanism that can be selectively utilized in accordance with the front utilization and rear utilization of the apparatus.

### BACKGROUND OF THE INVENTION

Now, a bill processing apparatus which is constructed in an ATM will be explained as an example. The bill processing apparatus of this type detachably accommodates a cartridge and a recovery box in which bills are put, and a clerk in charge occasionally attaches or detaches the cartridge and the recovery box and handles them at the start and end of business hours, or in cases of replenishing them with bills, recovering bills, inspecting the apparatus for maintenance, etc. Besides, in recent years, a demand has increased for the operations of ATMs consigned to third parties. Also in such a consigned operation of the ATM, it is requested to facilitate the operations of handling the cartridge and the recovery box and to attach or detach them in a short time.

Meanwhile, a front maintenance machine which a clerk in charge handles the cartridge and the recovery box from the front side of the apparatus body, and a rear maintenance machine which he/she handles them from the rear side of the apparatus body, are known as the ATMs of this type.

Such maintenance machines, however, are in the relationship that, when the apparatus is installed by specifying one of the front and rear maintenance machines, the specified one is given the precedence at the sacrifice of the other. Therefore, whether the apparatus is installed as the front maintenance machine or as the rear maintenance machine needs to be selected in accordance with the conditions of the installation, and both the sorts of machines need to be designed and prepared. Further, component exchanges necessitate two sorts of spare units; a spare unit dedicated to the front maintenance machine, and a spare unit dedicated to the rear maintenance machine, resulting in wasteful and uneconomical production and management of the respective spare units.

Therefore, this invention has for its object to provide a medium processing apparatus which includes a single bucket that can process media in common in both the case of utilizing the apparatus as a front maintenance machine and the case of utilizing it as a rear maintenance machine, whereby the apparatus is endowed with a common use function permitting it to be changed-over to and utilized as either of both the machines.

### DISCLOSURE OF THE INVENTION

This invention consists in a medium processing apparatus characterized by comprising a traveling bucket which has a medium reception opening inside, and a medium ejection opening outside, and which travels from a medium reception position to a medium ejection position; and reversible transportation means for allowing said traveling bucket to travel in a sense in one traveling direction or in a sense in the other traveling direction in which the first-mentioned sense of said bucket is reversed.

As a result, both a front maintenance machine and a rear maintenance machine can be coped with merely by including the traveling bucket which is utilizable in common so as to travel in one direction and in the other direction, so that the apparatus can be utilized by selecting either of both the machines.

Besides, even in a case where the mounting direction of the apparatus is altered for the front utilization or rear utilization of the maintenance machine, both the front and rear maintenance machines can be coped with by changing the sense of the traveling bucket to the amount of 180°, so that the common use of the traveling bucket can be attained. The sense of the traveling bucket can be easily changed, for example, in such a way that the direction of an upper unit including the traveling bucket is changed 180°. Besides, a common spare unit of one kind suffices for component exchange. Accordingly, both the machines can be coped with the same kind of spare unit as that of the traveling bucket, so that waste is eliminated in production and management to enhance a production control.

Besides, in this invention, in a case where a medium delivered from a cartridge is guided to an identification section and identified thereby, and where the medium is guided to an external medium take-out port and subjected to an ejection operation when identified to be capable of being issued, a medium processing apparatus is characterized by comprising a traveling bucket which has a medium reception opening inside, and a medium ejection opening outside, and which travels from a medium reception position to a medium ejection position; and traveling rails which allow said traveling bucket to reversibly travel in one direction of receiving media or in the other direction of ejecting media, and which allow said traveling bucket to travel in a sense in one traveling direction or in a sense in the other traveling direction where the first-mentioned sense of said bucket is reversed; wherein the medium ejection opening of said traveling bucket in said one traveling direction of said bucket that travels on said traveling rails corresponds to a first medium take-out port, while said medium ejection opening of said traveling bucket in said other traveling direction of said bucket that travels on said traveling rails corresponds to a second medium take-out port.

Therefore, at one medium ejection position, the medium ejection opening of the traveling bucket corresponds to the first medium take-out port so that the media can be taken out from one side, while at the other medium ejection position, the medium ejection opening of the traveling bucket corresponds to the second medium take-out port so that the media can be taken out from the other side. In this manner, the traveling bucket travels to one side or to the other side, whereby the media can be subjected to the ejection operation from the desired position.

Besides, in this invention, a medium processing apparatus is characterized in that, when any medium delivered from a cartridge is guided to an identification section and identified to be incapable of being issued, recovery means directly recovers the medium incapable of being issued, into a recovery box.

Therefore, when any medium incapable of being issued exists in a medium take-out operation, it can be immediately subjected to a recovery process, and when such media are collectively recovered, an efficient medium recovery operation is attained.

Besides, in this invention, a medium processing apparatus is characterized in that directions of taking out cartridges and the recovery box which are attached so as to be taken out of said apparatus are set to be one direction of said apparatus.

In this case, one side of the apparatus can be set as a maintenance side on which the cartridges and the recovery box are handled, in accordance with the conditions of the installation of the apparatus. Accordingly, the maintenance side can be set irrespective of the sense of the traveling bucket which is mounted in one sense or the other sense.

Besides, in this invention, a medium processing apparatus is characterized by comprising a movable partition plate which defines an inner space of the recovery box into one portion and the other portion so as to separately recover media into the one portion and the other portion.

In this case, notwithstanding that the traveling bucket lies at an identical stop position when the media are to be collectively recovered from the traveling bucket, the operation of recovering the media into one portion or into the other portion can be selected by the partitioning operation of the movable partition plate. By way of example, the media of different contents; media identified defective and forgotten media not taken up can be separately recovered and individually recovered into the identical recovery box.

Besides, in this invention, in a case where a medium delivered from a cartridge is guided to an identification section and identified thereby, and where the medium is guided to an external medium take-out port and subjected to an ejection operation when identified to be capable of being issued, a medium processing apparatus is characterized by comprising an upper unit which has a medium reception port for receiving the medium identified by the identification section, at a central part of a lower surface of said upper unit, and a medium ejection port at one end part of said upper unit; and movement permitting means for locating the medium ejection port of said upper unit onto a front side or a rear side of said apparatus.

In this case, when the mounting direction of the upper unit is changed 180°, the medium ejection port can be selected to the desired position of the front side or rear side of the apparatus, and the apparatus can be set for the utilization thereof as the front maintenance machine or for the utilization thereof as the rear maintenance machine, so that the maintenance side can be changed-over between the front side and the rear side merely by changing the mounting direction of the upper unit.

Here, the “maintenance” is a general term for the operations of attaching and detaching the cartridge or the recovery box, the operation of removing a medium jam, the maintenance of a routine inspection, etc. Besides, the “bucket” indicates a container in which the media are temporarily reserved. Further, the “medium” is a general term for bills, coins, cards, securities, etc. which are to be processed.

### BRIEF DESCRIPTION OF THE DRAWINGS

FIG. 1 is an external perspective view of a bill processing apparatus.

FIG. 2 is an internal constructional view of the bill processing apparatus.

FIG. 3 is a schematic constructional view of a rear maintenance machine as well as a front maintenance machine.

FIG. 4 is a partially-exploded perspective view showing the inversion allowing structure of each of the maintenance machines.

FIG. 5 is a side view of essential portions showing the relationship between a traveling bucket and traveling rails.

FIG. 6 is an explanatory view showing the traveling operation state of the traveling bucket.

FIG. 7 is an enlarged side view showing the bill reception structure of the traveling bucket.

FIG. 8 is an external perspective view of the traveling bucket.

FIG. 9 is an explanatory view showing several modes of the traveling bucket.

FIG. 10 is a control circuit block diagram of the bill processing apparatus.

FIG. 11 is a flow chart showing the outline of the dispensing process operation of the bill processing apparatus.

FIG. 12 is a flow chart showing a decision process operation for the stop position of the traveling bucket.

FIG. 13 is a flow chart showing a return operation for the traveling bucket.

FIG. 14 is a flow chart showing a bill piling operation in the rear maintenance machine.

FIG. 15 is a side view showing the hand-over position of the traveling bucket in the rear maintenance machine.

FIG. 16 is a flowchart showing a bill issuance operation in the rear maintenance machine.

FIG. 17 is a side view showing the issuance position of the traveling bucket in the rear maintenance machine.

FIG. 18 is a flow chart showing a collective recovery operation for forgotten bills not taken up, in the rear maintenance machine.

FIG. 19 is a side view showing a collective recovery status for the forgotten bills not taken up, in the rear maintenance machine.

FIG. 20 is a flow chart showing a collective recovery operation for reset bills in the rear maintenance machine.

FIG. 21 is a side view showing a collective recovery status for the reset bills in the rear maintenance machine.

FIG. 22 is a flow chart showing an overall recovery operation for reset bills.

FIG. 23 is a side view showing the hand-over position of the traveling bucket in the front maintenance machine.

FIG. 24 is a side view showing the issuance position of the traveling bucket in the front maintenance machine.

FIG. 25 is a side view showing a collective recovery status for forgotten bills in the front maintenance machine.

FIG. 26 is a side view showing a collective recovery status for reset bills in the front maintenance machine.

FIG. 27 is a side view showing a collective recovery status in the case where a recovery box in another embodiment is applied to the front maintenance machine.

FIG. 28 is a side view showing a collective recovery status in the case where the recovery box in the other embodiment is applied to the rear maintenance machine.

FIG. 29 is a schematic sectional view showing an upper unit in another embodiment.

### BEST MODE FOR CARRYING OUT THE INVENTION

One embodiment of this invention will now be described in detail with reference to the drawings.

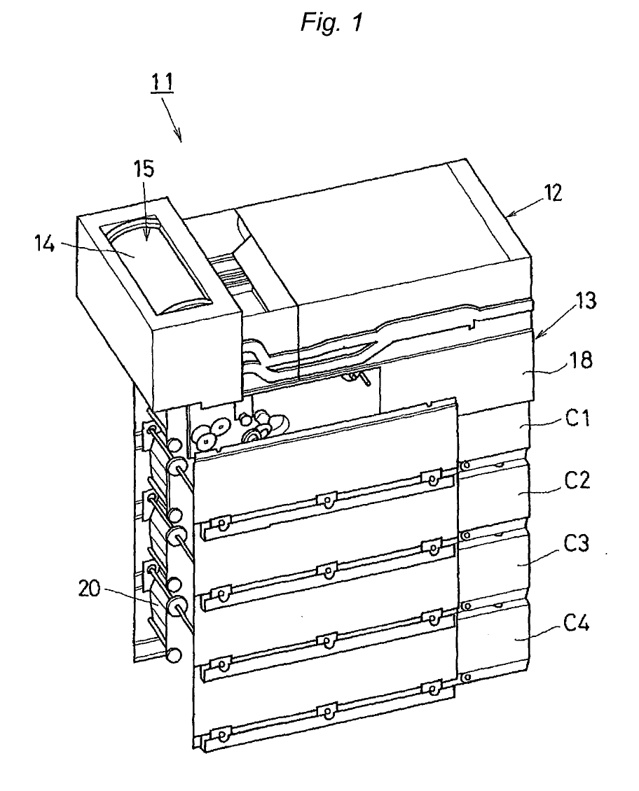

The drawings illustrate a bill processing apparatus which is constructed inside a bill dispenser of non-recycle type installed in a banking organ. Referring to FIG. 1, the bill processing apparatus 11 is so constructed that an upper unit 12 which is mounted allowing a 180° inversion in a horizontal direction, and a lower unit 13 which is fixedly attached under the upper unit 12, are vertically joined.

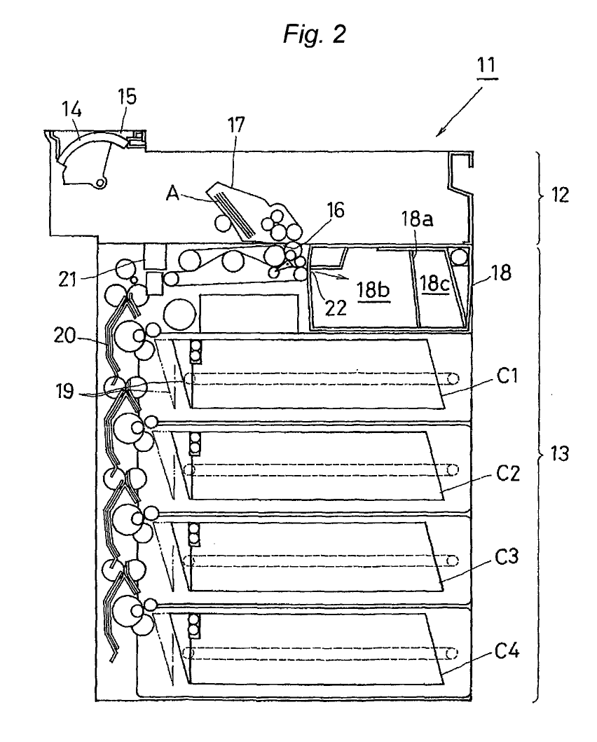

As shown in FIG. 2, the upper unit 12 is in the shape of an oblong rectangular parallelepiped. It has a bill take-out port 15 with a shutter 14, at one end part of the upper surface of the rectangular parallelepiped, and a bill reception port 16 at the central part of the lower surface thereof. It includes therein a traveling bucket 17 for ejecting bills as travels in the longitudinal direction thereof.

The lower unit 13 is mounted as a rear maintenance machine in which a recovery box 18 and first-fourth cartridges C1-C4 are disposed successively from above in the order mentioned, and in which the recovery box 18 and the first-fourth cartridges C1-C4 can be respectively detached in the horizontal direction and handled from the rear side of this lower unit 13.

Besides, the cartridges C1-C4 align and accommodate bills for the individual sorts of the bills in standing oblong postures, and each of them can put out one bill in such a way that the whole accommodated bills are pressed by a pressing plate 19 from behind so as to be urged under pressure onto the side of a front delivery transfer path 20.

In this case, the delivery transfer path 20 is connected to the delivery motion side of each of the cartridges C1-C4, whereby the bills delivered from the cartridge are handed over and transferred upwards one by one from the side of the lower unit 13 toward the bill reception port 16 located on the side of the upper unit 12. Besides, each bill delivered to the delivery transfer path 20 is guided to an identification section 21 at an upper position, and it is identified here as to the sort of this bill and whether it is true or false. The bill identified proper on this occasion is guided to the upper unit 12. In contrast, when the bill has been identified as one incapable of being issued, it is distributed onto the side of the recovery box 18 opposing to the identification section 21 in the horizontal direction until it is recovered through an inner-end recovery port 22 which opens in the opposing end face of the recovery box 18.

Besides, the recovery box 18 has its internal space partitioned into two, front and rear divisions by a partition plate 18a. A rejection recovery portion 18b which recovers rejected bills, and reset bills to be stated later is defined on the inner end side of the recovery box 18, while a forgotten-bill recovery portion 18c which recovers bills not taken up is defined on the outer end side. Thus, the respective bills are separated and recovered.

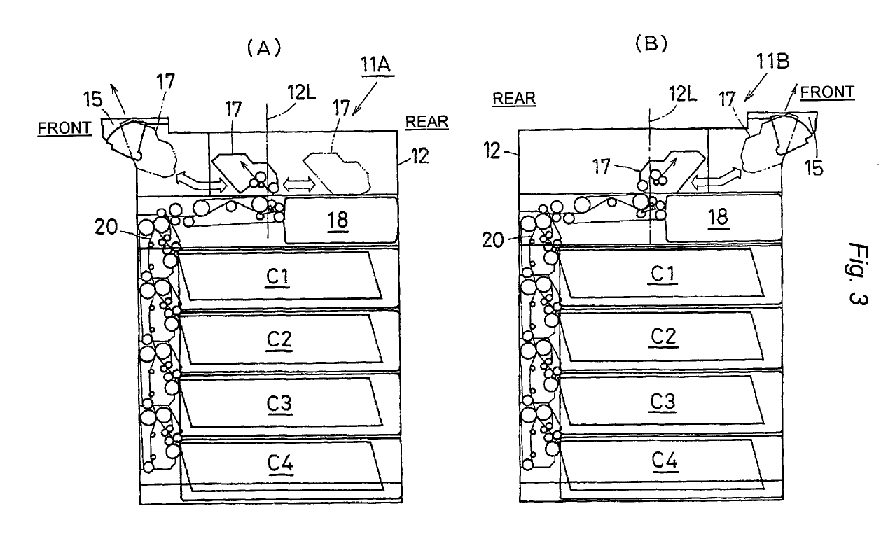

Meanwhile, the upper unit 12 is disposed allowing the 180° inversion in a state where a center line 12L corresponding to a middle position in the longitudinal direction forms the center of an inversion position. Usually, as shown in FIG. 3(A), the bill take-out port 15 provided at one end part of the upper unit 12 is located on the front side of the bill processing apparatus as the rear maintenance machine 11A, so that a clerk in charge or a maintenance engineer can put in and out the recovery box 18 and the cartridges C1-C4 from the rear side.

In addition, the bill processing apparatus 11 is installed so as to be utilizable by changing the rear maintenance machine 11A over to a front maintenance machine 11B. In case of using the apparatus as the front maintenance machine 11B, as shown in FIG. 3(B), the mounting direction of the upper unit 12 may be inverted 180° in the horizontal direction. On this occasion, a clerk in charge or a maintenance engineer can handle the recovery box 18 and the cartridges C1-C4 from the front side.

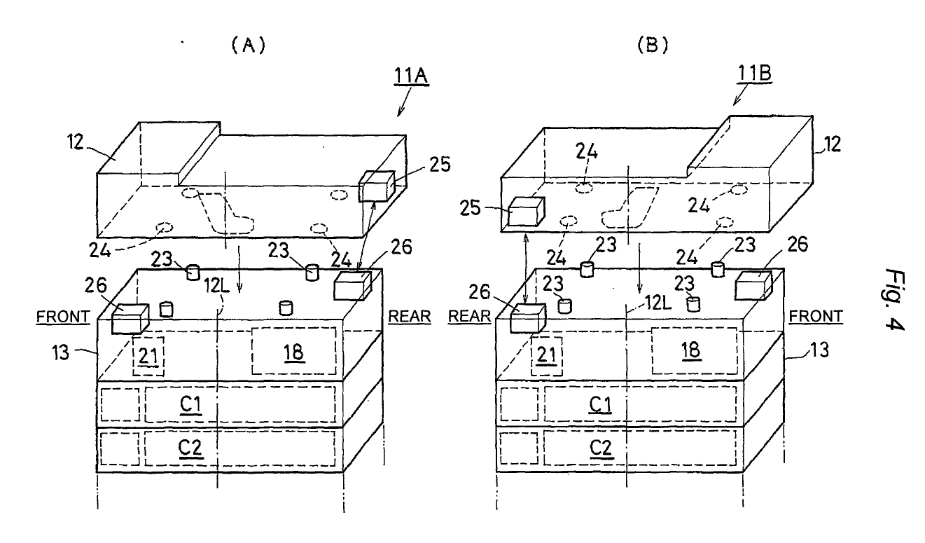

In this case, in order to allow the sense of the upper unit 12 in the longitudinal direction to be inverted 180°, as shown in FIGS. 4(A) and 4(B), four positioning protrusions 23, . . . which are symmetric in longitudinal and lateral directions with the center line 12L as an inversion reference are provided on the upper surface of the lower unit 13, while positioning recesses 24, . . . which correspond to the respective protrusions are formed in the lower surface of the upper unit 12 and are brought into engagement with the respective protrusions, and the front and rear positions of the upper unit 12 to be brought into engagement with the lower unit 13 are changed-over, whereby the units 12 and 13 can be detachably attached so as to select either the rear maintenance machine 11A or the front maintenance machine 11B. Besides, an upper connector 25 for electrically wiring and connecting the upper unit 12 in common is disposed on the lower surface of this upper unit, and lower connectors 26, . . . are respectively disposed at those front and rear symmetric positions of the upper surface of the lower unit 13 which correspond to the upper connector 25, so that the upper and lower units 12, 13 can be electrically connected for a drive control in both the front and rear maintenance machines.

In this manner, even in case of altering the direction of utilization as to the utilization of the rear maintenance machine 11A or the front maintenance machine 11B, the apparatus 11 can be conformed to either of the rear maintenance machine 11A and the front maintenance machine 11B by inverting the sense of the upper unit 12 to the amount of 180°. Besides, any component exchange can be coped with by a common spare unit of one kind.

In this case, the movement of the traveling bucket 17 inside the upper unit 12 is endowed with a traveling function to be stated later, which conforms to the changeover to either of the maintenance machines 11A, 11B in accordance with the inversion of the upper unit 12.

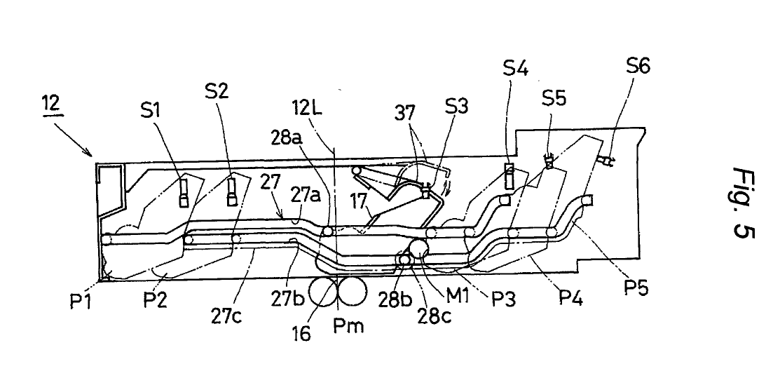

The traveling bucket 17 stated above has a reception opening 17a in its lower surface, and an ejection opening 17b in its upper surface. As shown in FIG. 5, the bucket 17 travels and moves in the longitudinal direction along traveling rails 27. The traveling rails 27 are disposed on both the sides of the upper unit 12 in the longitudinal direction thereof, and each of them is constructed by combining, for example, the two rail grooves 27a, 27b of an upper rail groove 27a and a lower rail groove 27b.

The upper bearing 28a of the traveling bucket 17 is fitted in the upper rail groove 27a so as to be rotatingly slidable in the direction of the rail, while the lower bearing 28b of the traveling bucket 17 is fitted in the lower rail groove 27b so as to be rotatingly slidable in the rail direction. Further, a pinion 28c which is rotated by receiving the rotation driving force of a bucket self-propelling motor M1 is mounted coaxially with the lower bearing 28b in a drive transmitting state where this pinion 28c meshes with a rack line 27c disposed along the lower rail groove 27b. Thus, the traveling bucket 17 is moved to advance or retreat in the longitudinal direction on the basis of the normal rotation or reverse rotation of the bucket self-propelling motor M1.

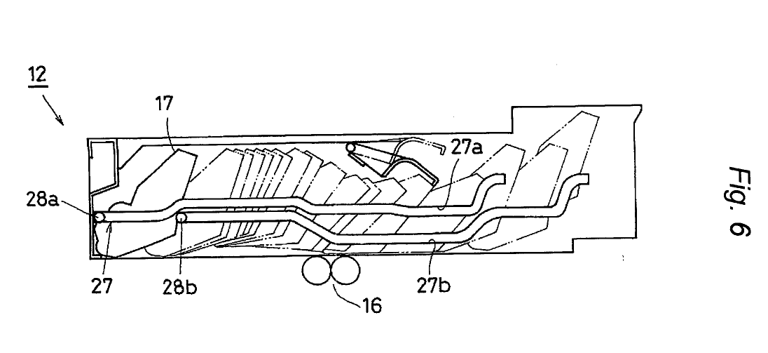

Besides, the upper and lower rail grooves 27a, 27b are combined in to any desired traveling guide shape by freely changing the distance between two points which separate these rail grooves vertically. Thus, as shown in FIG. 6, the angle of a piling posture in the longitudinal direction of the traveling bucket 17 can be freely altered depending upon a stop position, so that the receiving angle of the bills, the taking-out angle thereof and the dropping and recovering angle thereof can be set at desired angles.

By way of example, in case of using the apparatus as the rear maintenance machine 11A, when a first stop sensor S1 has sensed that the traveling bucket 17 has moved to the rearmost position, the traveling bucket 17 corresponds to a first recovery position P1 at which the reset bills are dropped and recovered from the traveling bucket 17 into the underlying recovery box 18. On this occasion, therefore, the bills piled in the traveling bucket 17 are inclined and set to an angle for collectively dropping and recovering them.

Further, at that sensing position of a second stop sensor S2 at which the traveling bucket 17 has moved somewhat ahead of the rearmost position, the traveling bucket 17 corresponds to a second recovery position P2 at which the bills not taken up are dropped and recovered from the traveling bucket 17 into the underlying recovery box 18. Therefore, the forgotten bills piled in the traveling bucket 17 are similarly inclined and set to an angle for collectively dropping and recovering them.

In addition, at the sensing position of a third stop sensor S3 which senses that the traveling bucket 17 has reached the position of the center line 12L, the traveling bucket 17 corresponds to a hand-over position Pm at which the bills supplied upwards from the delivery transfer path 20 of the lower unit 13 are received. On this occasion, therefore, the traveling bucket 17 is inclined and set to a piling angle which is suited to receive the bills from below.

Further, in case of using the apparatus as the front maintenance machine 11B through the inversion of the upper unit 12, at the sensing position of a fourth stop sensor S4 which senses that the traveling bucket 17 has reached a predetermined front position, the traveling bucket 17 corresponds to a third recovery position P3 at which the reset bills are dropped and recovered from the traveling bucket 17 toward the underlying recovery box 18. On this occasion, therefore, the bills piled in the traveling bucket 17 are inclined and set to an angle for collectively dropping them.

At that sensing position of a fifth stop sensor S5 at which the traveling bucket 17 has moved somewhat ahead of the front position, the traveling bucket 17 corresponds to a fourth recovery position P4 at which the bills not taken up are dropped and recovered from the traveling bucket 17 into the underlying recovery box 18. Therefore, the forgotten bills piled in the traveling bucket 17 are similarly inclined and set to an angle for collectively dropping and recovering them.

Besides, at the sensing position of a sixth stop sensor S6 which senses that the traveling bucket 17 has reached the frontmost end, the traveling bucket 17 corresponds to an issuance position P5 at which the bills are issued. On this occasion, therefore, the bills piled in the traveling bucket 17 are inclined and set to an angle at which they can be collectively taken out obliquely from above.

Next, there will be described a process for piling bills in the case of operating the traveling bucket 17.

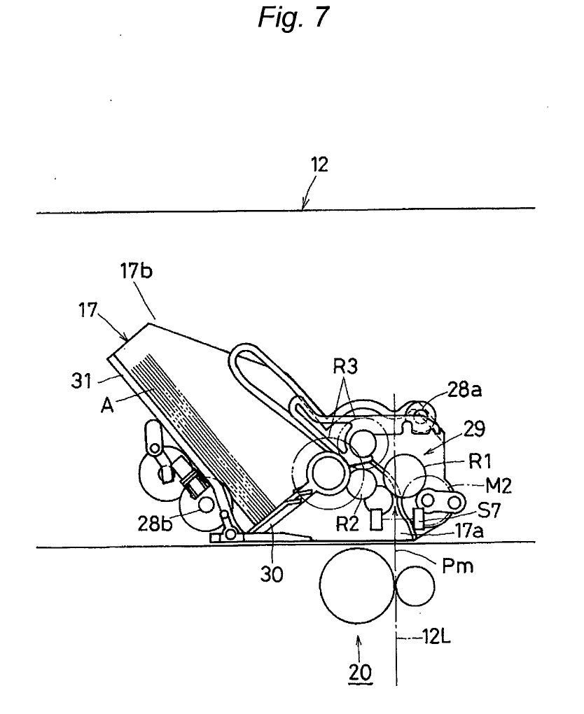

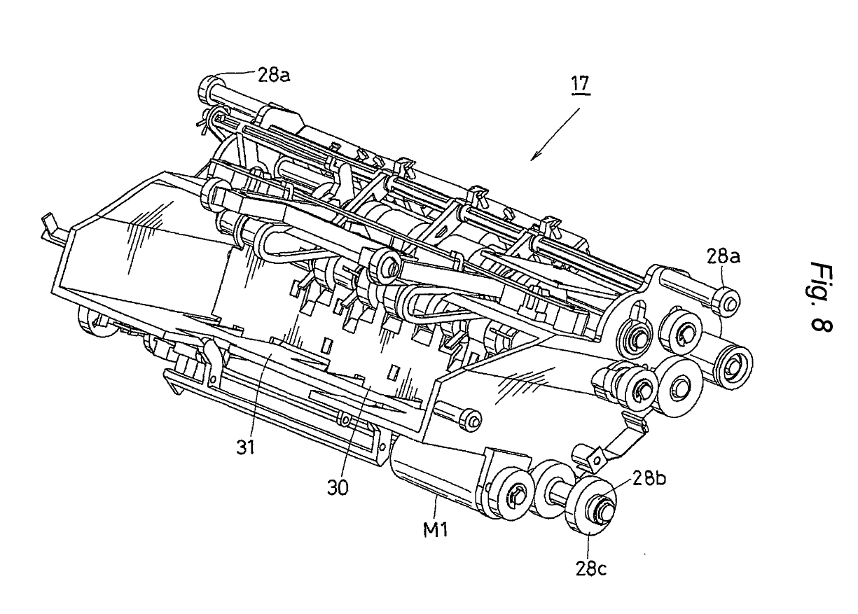

As shown in FIGS. 7 and 8, the traveling bucket 17 is such that its reception opening 17a corresponds to the terminal end of the underlying delivery transfer path 20 at the bill hand-over position Pm of the lower unit 13, whereby the bills are handed over to the overlying reception opening 17a one by one.

Disposed under the traveling bucket 17 is a pinching transfer path 29 for accepting the bills A as consists of a sensor S7, a transfer roller R1, a touch roller R2, a piling roller R3, . . . . The bills A accepted here lean against a bottom plate 30 and an inclined plate 31 in the traveling bucket 17, and are piled at a suitable inclination angle.

Besides, the traveling bucket 17 includes a mode changeover motor M2, and it can be changed-over into a piling mode, a transfer or issuance mode or a recovery mode to be explained below.

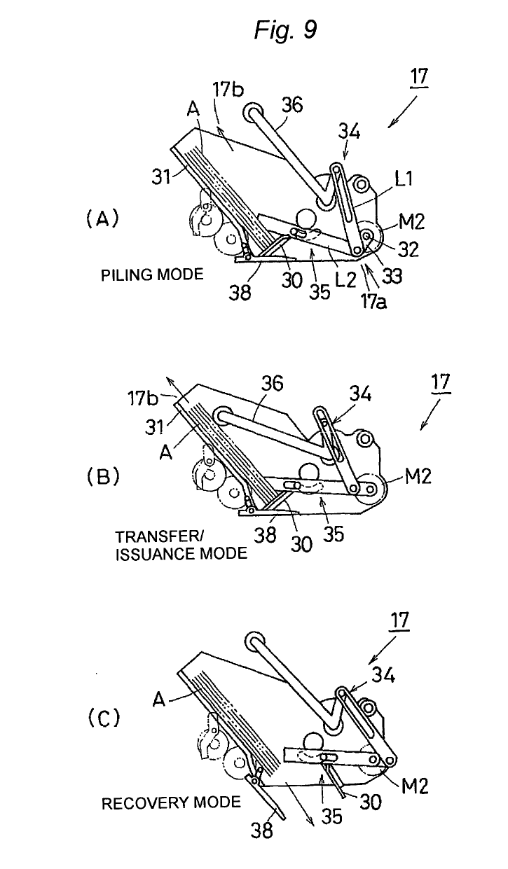

FIG. 9(A) shows the piling mode in the case where the traveling bucket 17 is held stopped at an initialized reference position. The piling mode is a mode in the case where the traveling bucket 17 stops at the bill hand-over position of the center line 12L and piles the received bills one by one. On this occasion, the piling operation is performed by bringing the mode changeover motor M2 into the piling mode.

Next, the mode changeover structure of the traveling bucket 17 will be described. A bill pressing mechanism 34 and a bottom-plate shutting mechanism 35 are respectively coupled to the main shaft 32 of the mode changeover motor M2 through a short lever 33. The bill pressing mechanism 34 couples a bill pressing lever 36 to the short lever 33 through a first link L1 so that the bill pressing lever 36 can move to an advanced bill pressing position and a retreated standby position. In the piling mode, the bill pressing lever 36 is retreated from the pressing position into a standby status, and the bills guided into the piling space from below are piled one by one.

Besides, the bottom-plate shutting mechanism 35 couples a second link L2 for driving the bottom plate 30, to the short lever 33 so that the second link L2 can move to an advanced bottom-plate closing position and a retreated bottom-plate opening position. In the piling mode, the second link L2 is advanced and moved in a closing direction so as to pile the bills guided here, on the bottom plate 30.

FIG. 9(B) shows a case where the traveling bucket 17 is changed-over into the transfer mode or the issuance mode. The same operation is performed in both the transfer and issuance modes. The transfer mode is a mode which is used when the traveling bucket 17 travels while containing the bills. The piled bills are pressed under a comparatively light pressure by the bill pressing lever 36, and they maintain a piled state where they are clipped between the lever 36 and the inclined plate 31, where by the bills are prevented from being disordered or scattered during the traveling.

The issuance mode is a mode which is used when the bills in the piled state after being transferred are allowed to be collectively drawn out of the ejection opening 17b located at the upper part of the bucket. Herein, the bills in an aligned and piled state are lightly clipped by the bill pressing lever 36 similarly to the above, whereby a user can draw out the bills from the ejection opening 17b in the clipped condition.

FIG. 9(C) shows a case where the traveling bucket 17 is changed-over into the recovery mode. The recovery mode is a mode which is used when the bills piled in the traveling bucket 17 are collectively dropped and recovered into the underlying recovery box 18. When the traveling bucket 17 is changed-over into the recovery mode upon its stop over the recovery box 18, the bottom-plate shutting mechanism 35 is driven to open, and the bills in the traveling bucket 17 are collectively dropped and recovered into the underlying recovery box 18.

The recovery here is classified into the collective recovery of the forgotten bills and that of the rejected bills. In a case where a user has forgotten taking up the bills after the issuance of the bills, the next transaction cannot be performed in a condition left intact. Therefore, the bills not taken up are recovered into the forgotten-bill recovery portion 18c of the recovery box 18 so as to prepare for the next transaction.

Besides, in a case where a transfer failure such as jam has occurred midway of the transfer process, the pertinent transaction needs to be invalidated once. In this regard, the bills already piled in the traveling bucket 17 at that time are recovered into the rejection recovery portion 18b of the underlying recovery box 18 so as to prepare for the next transaction.

In the figures, numeral 37 designates a piling guide plate, and numeral 38 a bottom-plate auxiliary guide plate.

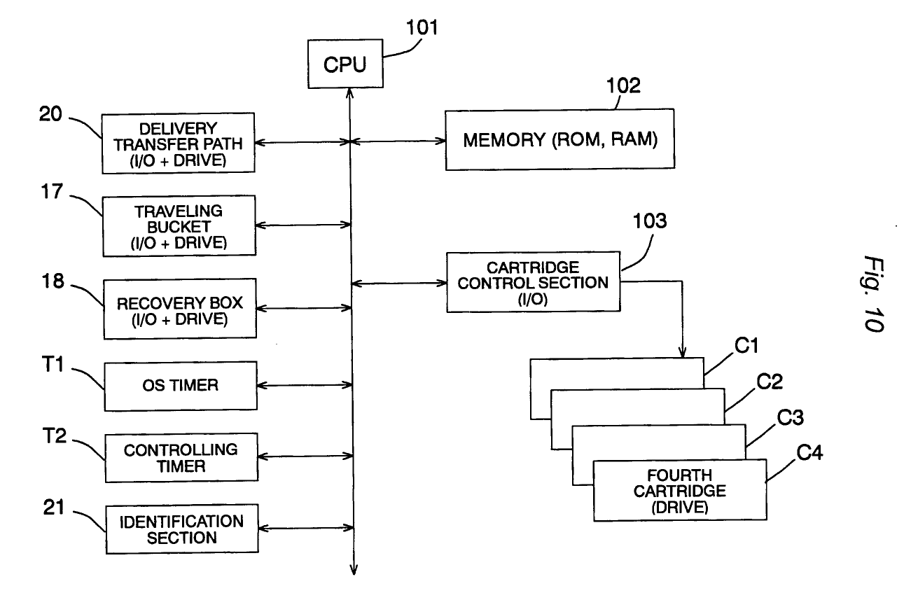

FIG. 10 shows a control circuit block diagram of the bill processing apparatus 11. A CPU 101 controls circuit devices and the piling mode, transfer mode or issuance mode, and recovery mode in a bill dispensing process in accordance with programs stored in a memory 102, and it stores control data and transaction data on this occasion in the memory 102 so as to manage the data.

Each time a request for dispensing bills is made, the CPU 101 controls a cartridge control section 103 so as to designate specified bills accommodated for the individual sorts of bills in the first-fourth cartridges C1-C4, on the basis of the request, and to deliver the number(s) of the bills requested to be dispensed, from the corresponding one(s) of the cartridges C1-C4.

Besides, sensors are disposed on the delivery transfer path 20, and distributing flappers are disposed at transfer branch positions, whereby the bills delivered from the cartridges C1-C4 are distributed in directions corresponding to the identified results of the identification section 21. By way of example, when the bill has been identified as a proper one capable of being issued, it is branched and transferred from the hand-over position Pm toward the overlying traveling bucket 17, and when the bill has been identified as an improper one incapable of being issued, it is branched and transferred toward the recovery box 18 opposing in the horizontal direction.

Also, the drive time periods and traveling time periods of the various devices are kept by an OS timer T1 and a controlling timer T2.

In addition, at the bill putting-in and -out parts and transfer positions of the traveling bucket 17, delivery transfer path 20, cartridges C1-C4, recovery box 18, etc., bill sensors are disposed so as to sense and check the bills, and shutters are disposed so as to ensure a bill transfer management by driving the shutters to open and close on each occasion.

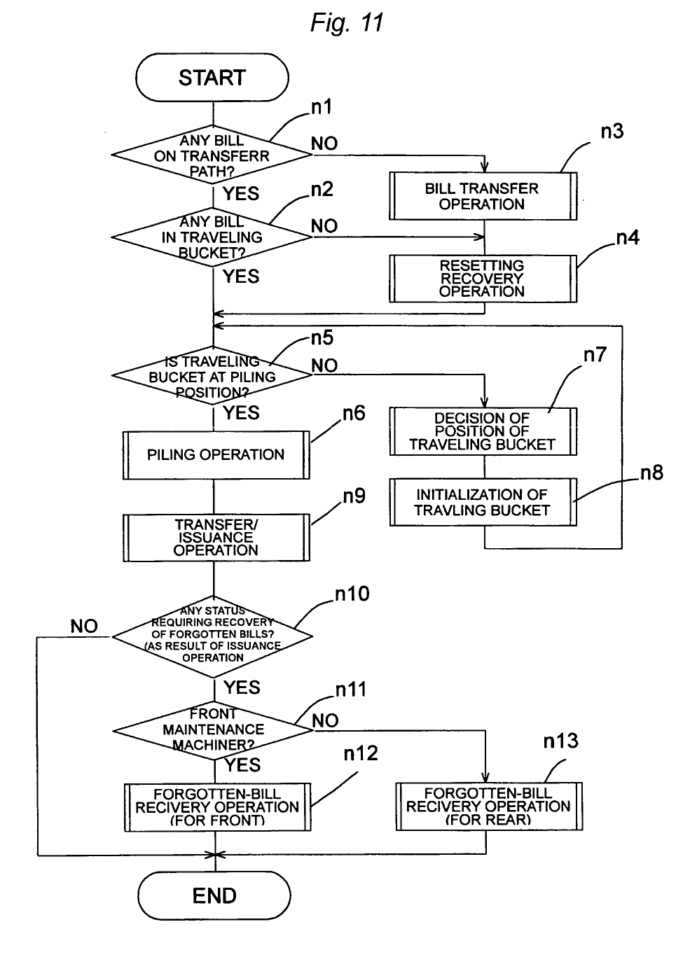

The outline of the dispensing process operation of the bill processing apparatus 11 thus constructed will be described with reference to a flow chart shown in FIG. 11.

Now, when a dispensing transaction signal is inputted to the CPU 101 in accordance with a dispensing transaction, this CPU 101 confirms before a dispensing process, that jammed bills or the likes do not remain on the delivery transfer path 20 (step n1); and

that any bill in a last process does not remain in the traveling bucket 17, either (step n2).

On this occasion, if any bill remains on the delivery transfer path 20, a transfer process is performed in order to remove the bill (step n3); and

if any bill remains in the traveling bucket 17, a recovery process is performed for recovering the bill into the recovery box 18 (step n4).

If the CPU 101 confirms a transaction allowing status where the remaining bill exists on or in neither of the delivery transfer path 20 nor traveling bucket 17 mentioned above (step n5),

it starts a piling operation upon confirming that the traveling bucket 17 lies stopped at its initialized hand-over position Pm corresponding to the intermediate position of the upper unit 12 (step n6).

When the traveling bucket 17 does not lie stopped at the hand-over position Pm, any bill cannot be handed over to the traveling bucket 17, and hence, this traveling bucket 17 is moved to the initialized hand-over position Pm (steps n7-n8).

Thereafter, when the traveling bucket 17 has completed a bill piling operation for the designated sorts and numbers of bills at the hand-over position Pm, it is moved to travel from the hand-over position Pm to the issuance position P5, at which the bills can be issued (step n9).

When a user has drawn out the bills to-be-dispensed A . . . from the traveling bucket 17 stopped at the issuance position P5 so as to allow the drawing-out, the shutter 14 of the bill take-out port 15 is closed, and the traveling bucket 17 is returned to the original initialized position. Then, one dispensing process is ended (step n10).

In a case where the bills are not taken up after the dispensing operation, the shutter 14 of the bill take-out port 15 is closed, and the operation of recovering the forgotten bills is thereafter performed. Regarding the recovery operation here, when the apparatus is used as the front maintenance machine 11B, the recovery box 18 lies on the front side. Therefore, the traveling bucket 17 is positioned by slightly moving it toward the fourth recovery position P4 on the front side, and the bills are thereafter dropped from the position P4 into the forgotten-bill recovery portion 18c of the recovery box 18 so as to be collectively recovered (steps n11-n12).

In contrast, when the apparatus is used as the rear maintenance machine 11A, the recovery box 18 lies on the rear side. Therefore, the traveling bucket 17 is positioned by greatly moving it toward the second recovery position P2 on the rear side, and the bills are thereafter dropped into the forgotten-bill recovery portion 18c of the recovery box 18 so as to be collectively recovered similarly to the above (step n13).

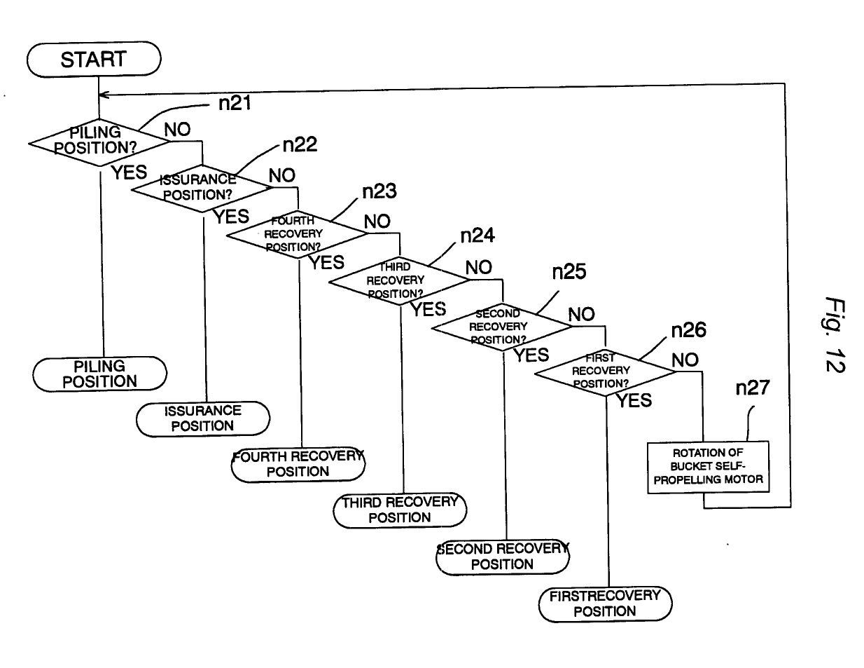

Next, a decision process operation for the stop position of the traveling bucket 17 will be described with reference to a flow chart shown in FIG. 12.

Now, when the traveling bucket 17 lies on the center line 12L of the upper unit 12 and is stopped at the initialized hand-over position Pm, the third stop sensor S3 senses this state, and the CPU confirms that the operation of piling bills is possible (step n21).

Besides, when the traveling bucket 17 lies stopped at the issuance position P5, the sixth stop sensor S6 senses this state, and the CPU confirms that the drawing-out of issued bills is possible (step n22).

Further, when the traveling bucket 17 lies stopped at the fourth recovery position P4, the fifth stop sensor S5 senses this state, and the CPU confirms that the collective recovery operation for forgotten bills not taken up is possible in the utilization of the apparatus as the front maintenance machine 11B (step n23).

Likewise, when the traveling bucket 17 lies stopped at the third recovery position P3, the fourth stop sensor S4 senses this state, and the CPU confirms that the collective recovery operation for reset bills is possible in the utilization as the front maintenance machine 11B (step n24).

Besides, when the traveling bucket 17 lies stopped at the second recovery position P2, the second stop sensor S2 senses this state, and the CPU confirms that the collective recovery operation for reset bills is possible in the utilization of the apparatus as the rear maintenance machine 11A (step n25).

Likewise, when the traveling bucket 17 lies stopped at the first recovery position P1, the first stop sensor S1 senses this state, and the CPU confirms that the collective recovery operation for forgotten bills not taken up is possible in the utilization as the rear maintenance machine 11A (step n26).

Besides, in a case where the sensing signal of any stop sensor is not obtained, the traveling bucket 17 is caused to travel, and its current position is precisely checked (step n27).

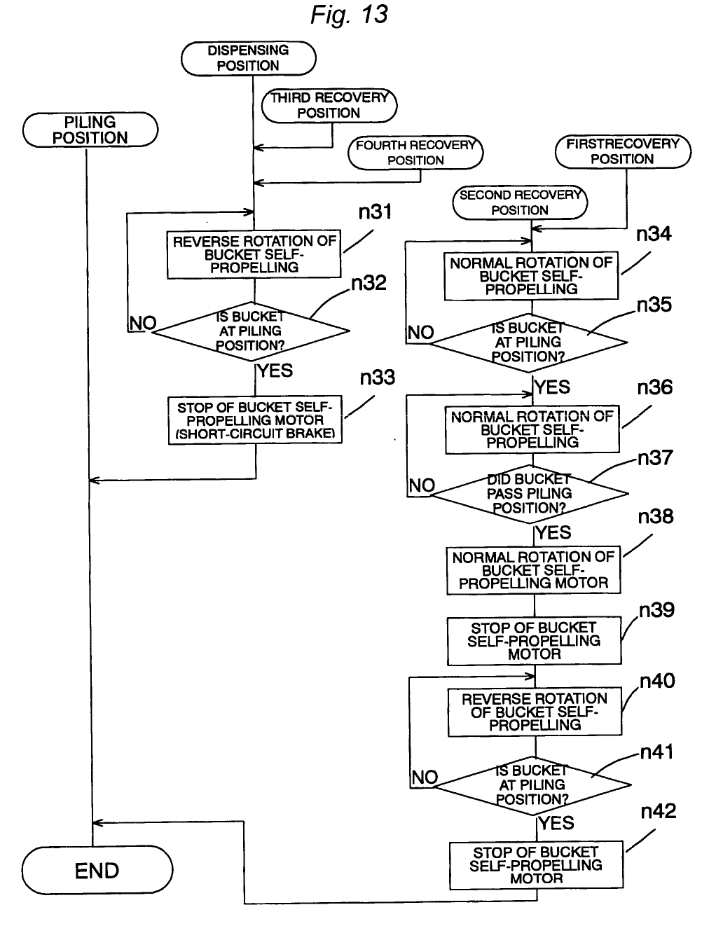

Next, the return operation of returning the traveling bucket 17 to its initialized position will be described with reference to a flow chart shown in FIG. 13.

When the CPU 101 has sensed and confirmed through the third stop sensor S3 that the traveling bucket 17 lies stopped at the hand-over position Pm of the upper unit 12, it decides the completion of the return operation because the position Pm is the initialized reference position.

However, when the traveling bucket 17 lies stopped at any of the issuance position P5, third recovery position P3 and fourth recovery position P4, the CPU drives and reverses the bucket self-propelling motor M1 so as to return the traveling bucket to the reference hand-over position Pm. Thereafter, when the CPU confirms that the traveling bucket has returned to the initialized hand-over position Pm, the return operation is completed (steps n31-n33).

Besides, when the traveling bucket 17 is to be subjected to the return operation from the second recovery position P2 or first recovery position P1, the CPU 101 drives and normally rotates the bucket self-propelling motor M1 so as to return the traveling bucket to the reference hand-over position Pm (steps n34-n35).

Upon confirming that the traveling bucket 17 has been returned to the hand-over position Pm, the CPU immediately stops the traveling of the traveling bucket 17, and it makes fine adjustments such as canceling an excessive component, thereby to precisely position and stop the traveling bucket 17 at the hand-over position Pm (steps n36-n40).

In addition, upon confirming that the traveling bucket 17 has been returned to the initialized hand-over position Pm, the CPU 101 completes the return operation (steps n41-n42).

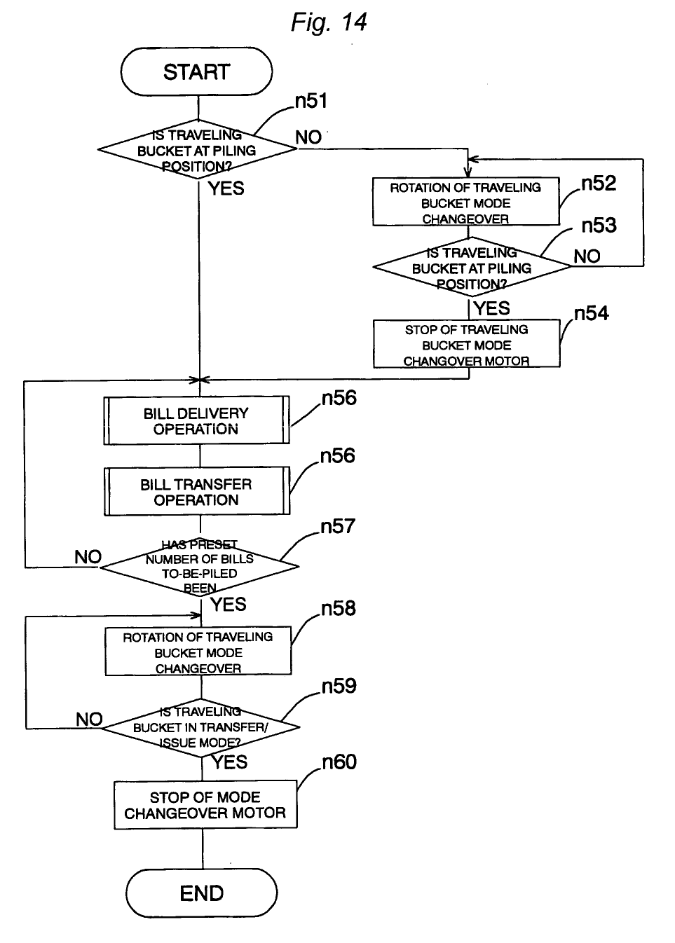

Next, a bill piling operation in the case of utilizing the apparatus as the rear maintenance machine 11A will be described with reference to a flow chart shown in FIG. 14.

Now, when the signal of the piling mode is inputted to the CPU 101, this CPU 101 decides whether or not the traveling bucket 17 lies stopped at the initialized hand-over position Pm (step n51); and

unless the traveling bucket 17 lies stopped at the hand-over position Pm, the piling operation cannot be performed, so that the traveling bucket 17 is moved to travel and is stopped at the hand-over position Pm (steps n52-n54).

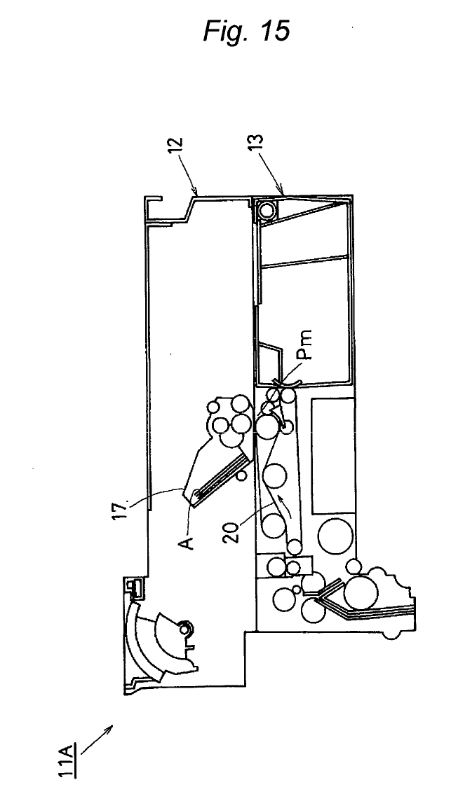

Subsequently, upon confirming that the traveling bucket 17 lies stopped at the hand-over position Pm as shown in FIG. 15, the CPU 101 delivers bills from a designated one of the cartridges C1-C4 (step n55).

The delivered bills A . . . are subjected to the piling operation toward the overlying traveling bucket 17 through the delivery transfer path 20 one by one (step n56).

When the designated number of bills requested to be dispensed are piled in the traveling bucket 17 (step n57),

the CPU 101 changes the piling mode into the transfer mode and causes the traveling bucket 17 to travel the position of the bill take-out port 15, and it allows the user to take out the bills from this bill take-out port (steps n58-n60).

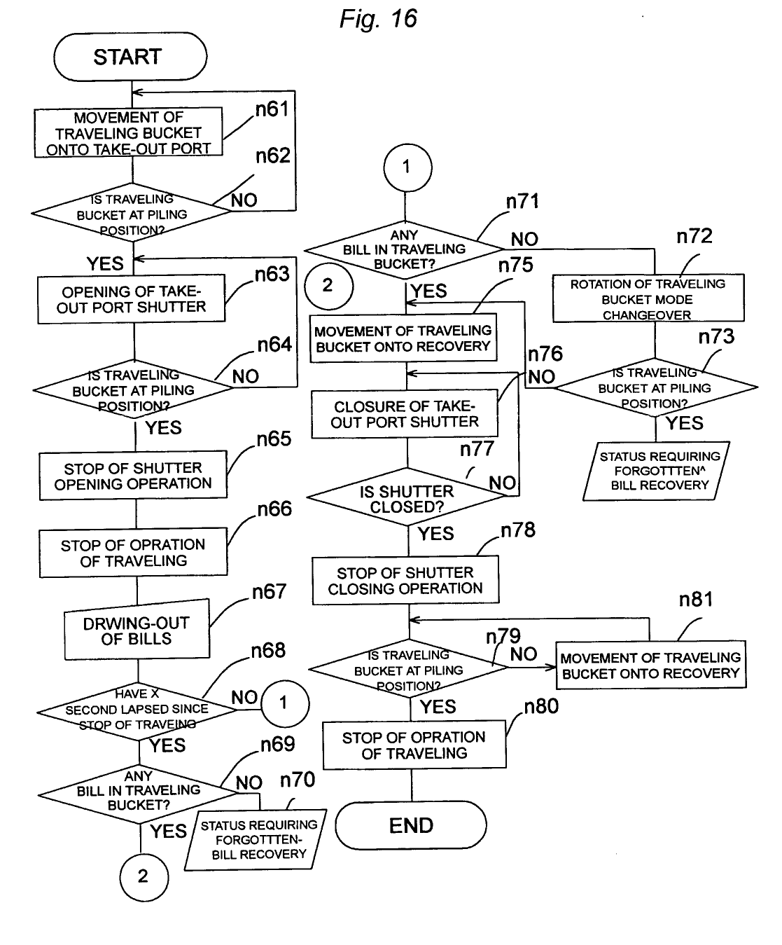

Next, a bill issuance operation in the case of utilizing the apparatus as the rear maintenance machine 11A will be described with reference to a flow chart shown in FIG. 16.

Now, when the signal of the issuance mode is inputted to the CPU 101, this CPU 101 moves the traveling bucket 17 having completed the piling operation, so as to travel toward the issuance position P5 (step n61); and

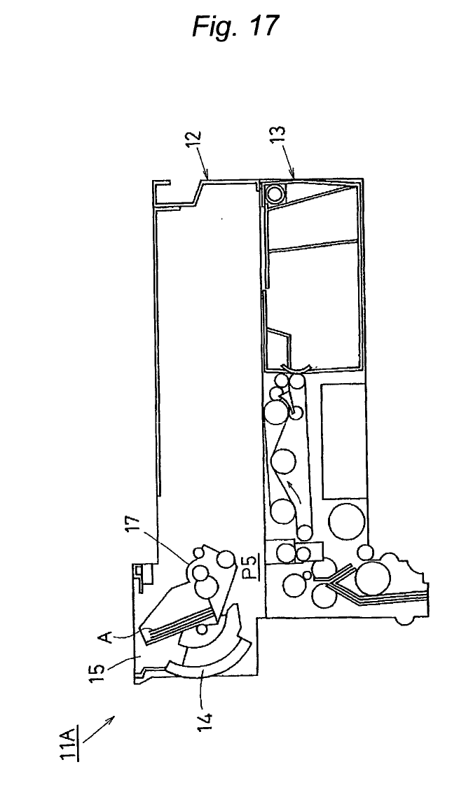

thereafter, upon confirming that the traveling bucket 17 has been guided to the issuance position P5 as shown in FIG. 17 (step n62),

the CPU 101 establishes the issuance mode, and opens the shutter 14 and allows the user to perform a bill drawing-out action from above the traveling bucket 17 stopped at the issuance position P5 (steps n63-n67).

On this occasion, even when a preset wait time for the drawing-out has lapsed, the bill drawing-out action is not performed, or any forgotten bill not taken up remains in the traveling bucket 17, the CPU performs the operation of recovering the forgotten bill (steps n68-n74).

In contrast, when the bill drawing-out action is normally performed, the CPU 101 moves the traveling bucket 17 so as to travel to the original hand-over position Pm, and it operates the shutter 14 of the bill take-out port 15 so as to close (steps n75-n78)

When the traveling bucket 17 has been moved in its returning direction and returned to the original hand-over position Pm, the CPU 101 stops this traveling bucket 17, thereby to end one issuance process (steps n79-n81).

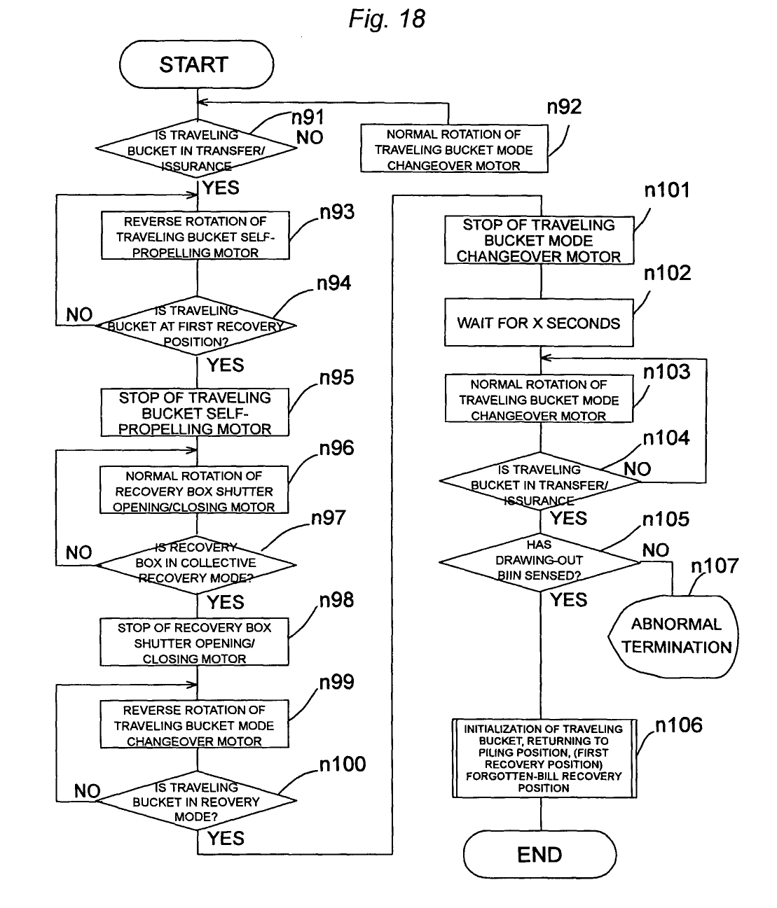

Next, the collective recovery operation for forgotten bills not taken up, in the case of utilizing the apparatus as the rear maintenance machine 11A will be described with reference to a flow chart shown in FIG. 18.

Now, when the CPU 101 has sensed through an unshown sensor that any forgotten bill not taken up exists in the traveling bucket 17, it checks if this bucket is in the transfer mode or issuance mode, and in neither of the modes, it changes-over the process mode of the traveling bucket into the transfer mode or issuance mode (steps n91-n92).

Upon confirming the transfer mode or issuance mode, the CPU 101 moves the traveling bucket 17 so as to correspond to the first recovery position P1 corresponding to the forgotten-bill recovery portion 18c of the recovery box 18, and it stops this bucket at the position corresponding to the first recovery position P1 (steps n93-n95);

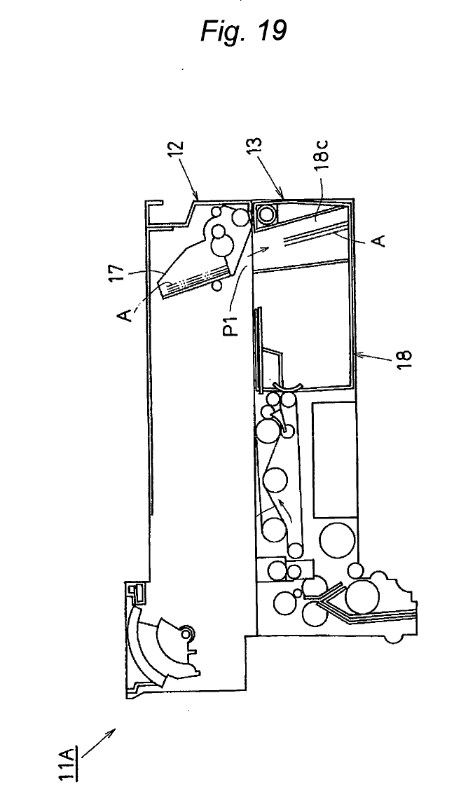

after the stop of the traveling bucket 17, the CPU 101 opens the upper shutter of the forgotten-bill recovery portion 18c as shown in FIG. 19 and confirms the recovery mode (steps n96-n98); and

thereafter, the CPU opens the bottom plate 30 and collectively drops the forgotten bills in the traveling bucket 17, thereby to collectively recover the bills into the forgotten-bill recovery portion 18c of the underlying recovery box 18 (steps n99-n101).

Upon confirming the lapse of a time period required for the collective recovery, the CPU 101 closes the upper shutter of the forgotten-bill recovery portion 18c of the recovery box 18 and brings the bottom plate 30 of the traveling bucket 17 back into its original closed position again, and thereafter, it moves the traveling bucket 17 so as to travel and return to the original hand-over position Pm, whereby the collective recovery process for the forgotten bills not taken up is ended (steps n102-n107).

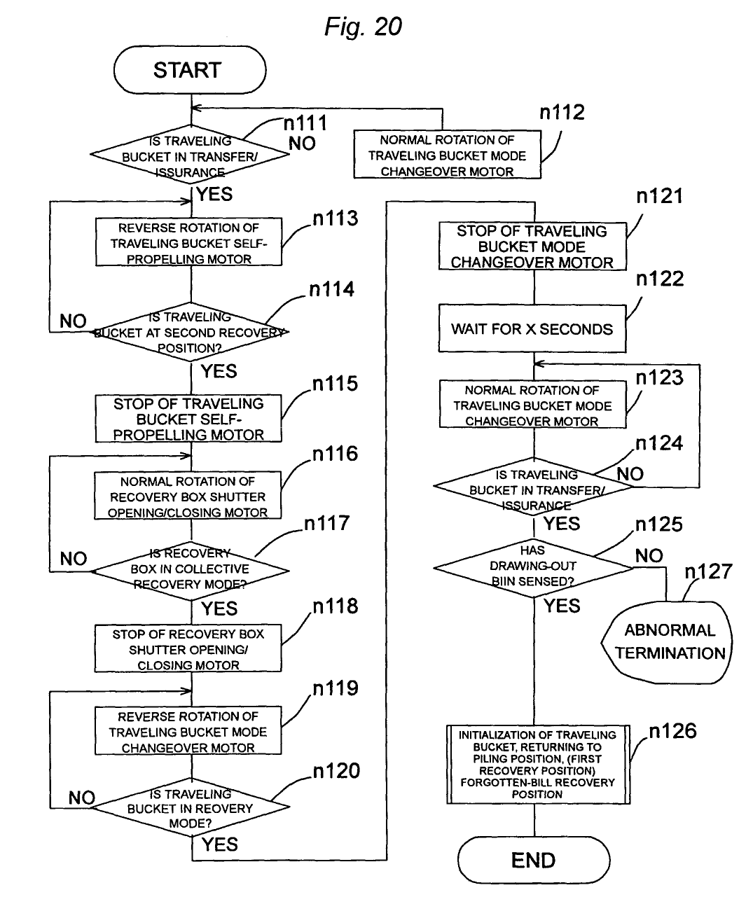

Next, the collective recovery operation for reset bills in the case of utilizing the apparatus as the rear maintenance machine 11A will be described with reference to a flow chart shown in FIG. 20.

Now, when a reset signal is inputted, the CPU 101 checks if the traveling bucket is in the transfer mode or issuance mode, and in neither of the modes, it changes-over the process mode of the traveling bucket into the transfer mode or issuance mode (steps n111-n112).

Upon confirming the transfer mode or issuance mode, the CPU 101 moves the traveling bucket 17 so as to correspond to the second recovery position P2 corresponding to the rejection recovery portion 18b of the recovery box 18, and it stops this traveling bucket at the position corresponding to the second recovery position P2 (steps n113-n115);

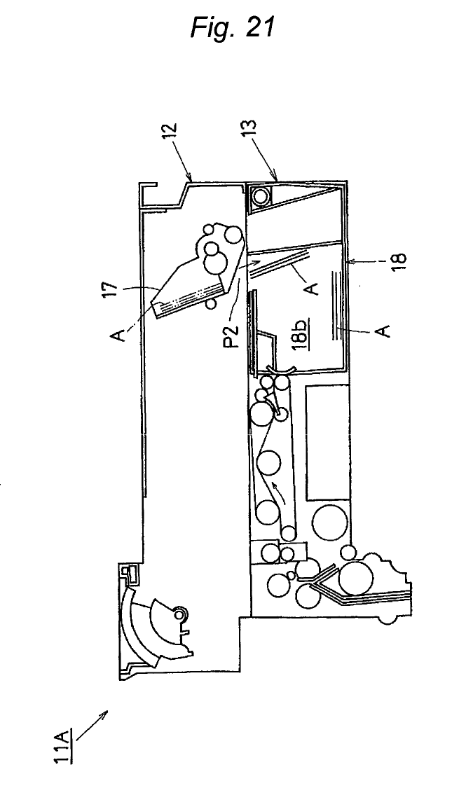

after the stop of the traveling bucket 17, the CPU 101 opens the upper shutter of the rejection recovery portion 18b as shown in FIG. 21 and confirms the recovery mode (steps n116-n118); and

thereafter, the CPU opens the bottom plate 30 and collectively drops the reset bills in the traveling bucket 17, thereby to collectively recover the bills into the rejection recovery portion 18b of the underlying recovery box 18 (steps n119-n121).

Upon confirming the lapse of a time period required for the collective recovery, the CPU 101 closes the upper shutter of the rejection recovery portion 18b and brings the bottom plate 30 of the traveling bucket 17 back into its original closed position again, and thereafter, it moves the traveling bucket 17 so as to travel and return to the original hand-over position Pm, whereby the collective recovery process for the reset bills is ended (steps n122-n127).

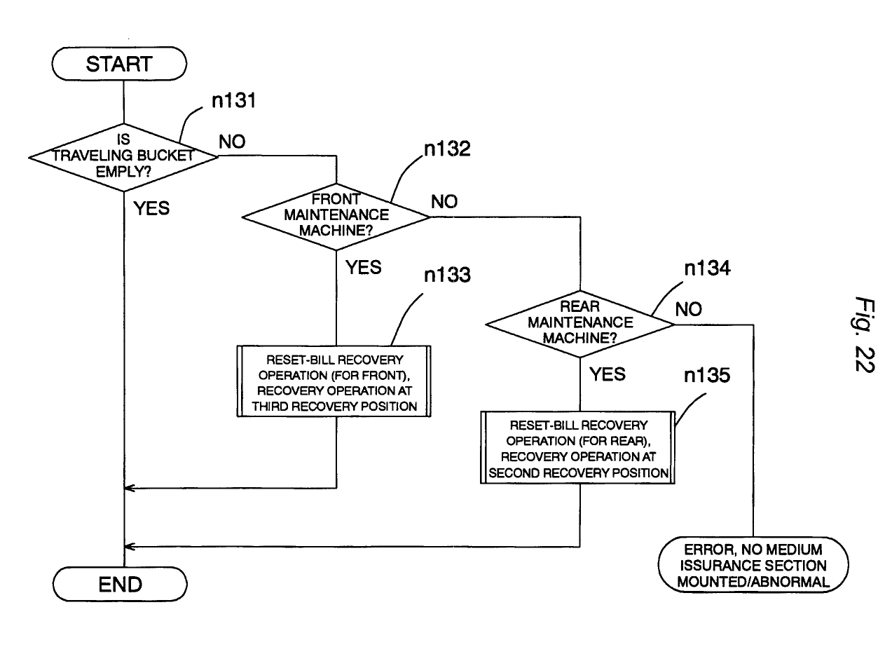

Next, a comprehensive recovery operation for reset bills will be described with reference to a flow chart shown in FIG. 22.

Now, when a reset signal has been inputted to the CPU 101, this CPU 101 senses and confirms that any bill remains in the traveling bucket 17, and upon the confirmation (step n131),

the CPU 101 decides whether or not the apparatus is currently utilized as the front maintenance machine 11B (step n132); and

subject to the utilization as the front maintenance machine 11B, a collective recovery position for the reset bills lies on the front side, and the CPU 101 stops the traveling bucket 17 at the third recovery position P3 corresponding to the rejection recovery portion 18b of the recovery box 18 so as to perform a recovery operation (step n133).

In contrast, if the apparatus is utilized as the rear maintenance machine 11A (step n134),

a collective recovery position for the reset bills lies on the rear side, and the CPU 101 stops the traveling bucket 17 at the second recovery position P2 corresponding to the rejection recovery portion 18b of the recovery box 18 so as to perform a recovery operation (step n135).

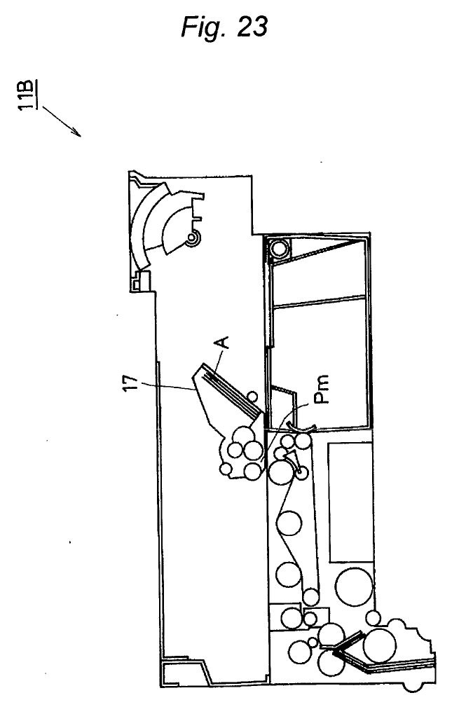

FIGS. 23-26 show the case of utilization where the upper unit 12 has its direction changed 180°, whereby the rear maintenance machine 11A already explained is changed-over to the front maintenance machine 11B. In this case, the sense of the traveling bucket 17 is changed 180° together with the upper unit 12.

Accordingly, even when the direction of the apparatus is changed as the front maintenance machine 11B in this manner, those movements of the traveling bucket 17 in which this traveling bucket 17 lies stopped at the hand-over position Pm and receives bills from below one by one so as to perform a piling operation are different merely symmetrically, and the piling operation itself is the same, as shown in FIG. 23. Therefore, similar functional effects are attained.

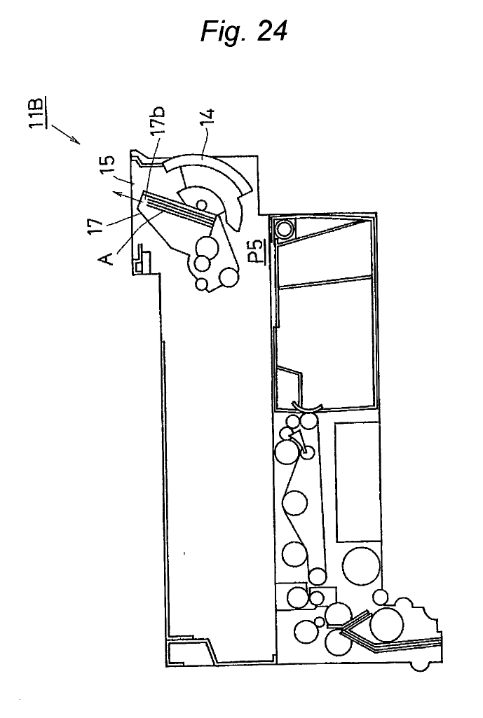

Besides, as shown in FIG. 24, the front maintenance machine 11B has a corresponding structure in which the traveling bucket 17 lies stopped at the issuance position P5, and the upper ejection opening 17b of this traveling bucket 17 corresponds to the bill take-out port 15, thereby to allow the collective take-out of the bills from above. In this manner, the movements of the traveling bucket for the take-out operation differ from those in the rear maintenance machine 11A merely symmetrically, and the issuance operation itself is the same. Therefore, similar functional effects are attained even when the apparatus is utilized as the front maintenance machine 11B.

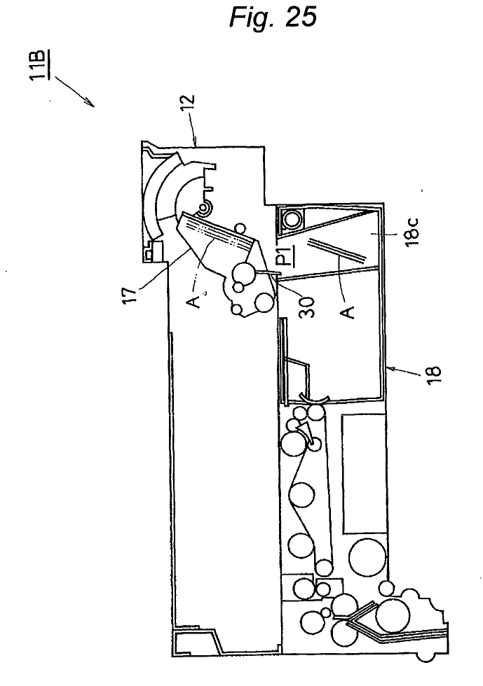

FIG. 25 shows a recovery operation for forgotten bills not taken up. The front maintenance machine 11B has a corresponding structure in which the traveling bucket 17 lies stopped at the first recovery position P1, and the bottom plate 30 of this traveling bucket 17 corresponds to the upper surface of the forgotten-bill recovery portion 18c, so as to collectively drop and recover the bills into the underlying forgotten-bill recovery portion 18c by opening the bottom plate 30 of the traveling bucket 17. In this manner, the movements of the traveling bucket for the recovery operation differ from those in the rear maintenance machine 11A merely symmetrically, and the forgotten-bill recovery operation itself is the same. Therefore, similar functional effects are attained even when the apparatus is utilized as the front maintenance machine 11B.

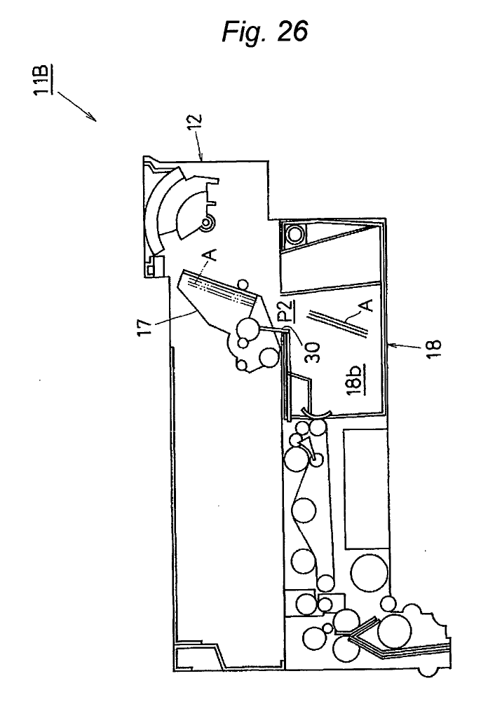

FIG. 26 shows a recovery operation for reset bills. The front maintenance machine 11B has a corresponding structure in which the traveling bucket 17 lies stopped at the second recovery position P2, and the bottom plate 30 of this traveling bucket 17 corresponds to the upper surface of the rejection recovery portion 18b, so as to collectively drop and recover the bills into the underlying rejection recovery portion 18b by opening the bottom plate 30 of the traveling bucket 17. In this manner, the movements of the traveling bucket for the recovery operation differ from those in the rear maintenance machine 11A merely symmetrically, and the reset-bill recovery operation itself is the same. Therefore, similar functional effects are attained even when the apparatus is utilized as the front maintenance machine 11B.

Next, another embodiment of a recovery box will be described.

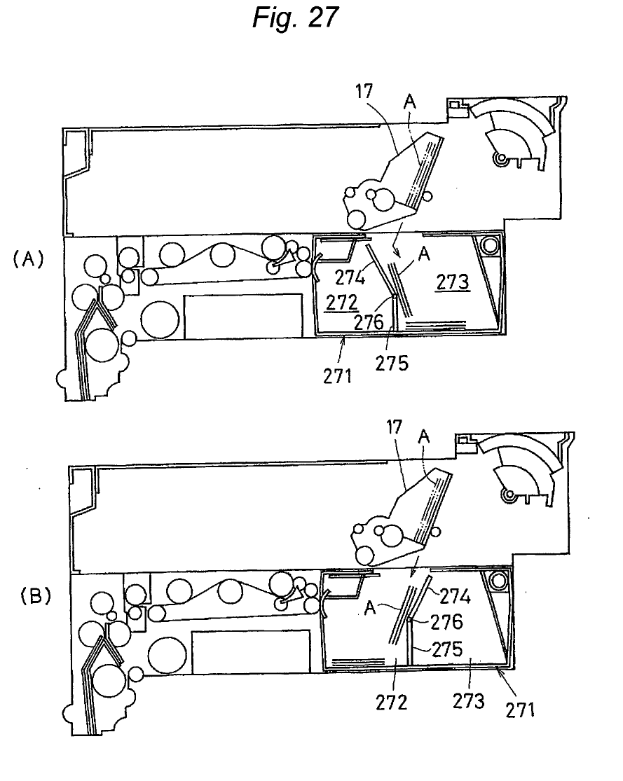

FIG. 27 shows the other embodiment of the recovery box applied to the front maintenance machine 11B. The recovery box 271 is such that the inner space of this recovery box is defined into a rejection recovery portion 272 and a forgotten-bill recovery portion 273 in the longitudinal direction thereof, and that a movable partition plate 274 for separately recovering bills A into one and the other portions is disposed. The movable partition plate 274 has its lower end pivotally mounted as an inclining arbor 276 on the upper end of a fixed partition plate 275 erected to the intermediate height of the inner space at the central part thereof, so as to incline in the longitudinal direction. This movable partition plate is subjected to an inclining operation in the longitudinal direction with the inclining arbor 276 as an inclining fulcrum, by a solenoid or the like not shown.

Thus, in spite of the identical stop position of the overlying traveling bucket 17, the bills can be collectively recovered by selecting a recovery operation for L forgotten bills as shown in FIG. 27(A) or a recovery operation for reset bills as shown in FIG. 27(B), through the partitioning operation of the movable partition plate 274. Besides, the bills of different contents; bills identified defective and the reset bills, and the forgotten bills can be separately recovered and individually managed inside the identical recovery box 271.

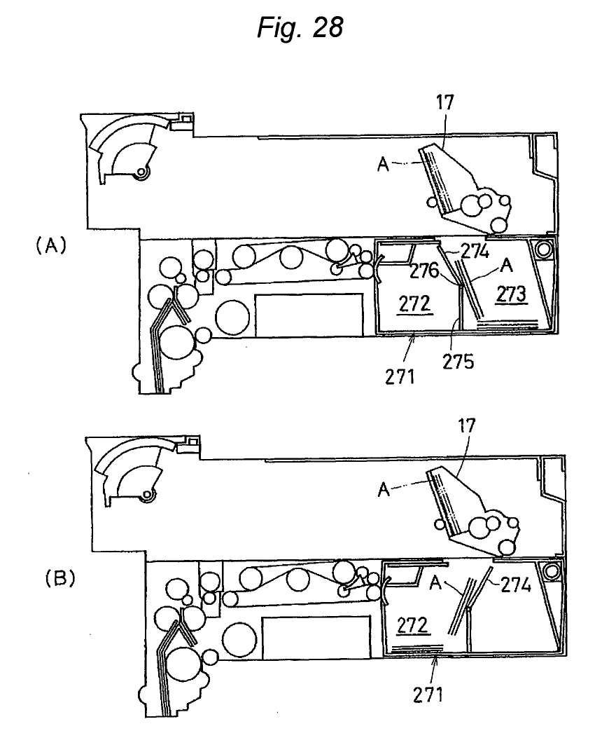

FIG. 28 shows another embodiment of a recovery box applied to the rear maintenance machine 11A. In this case, only the sense of the traveling bucket 17 is different, and the other points are the same as in FIGS. 27(A) and 27(B) referred to above. Therefore, even when the apparatus is utilized as the rear maintenance machine 11A, forgotten bills can be subjected to a recovery operation as shown in FIG. 28(A), and reset bills can be subjected to a recovery operation as shown in FIG. 28(B), so that similar functional effects are attained.

Next, another embodiment of an upper unit will be described.

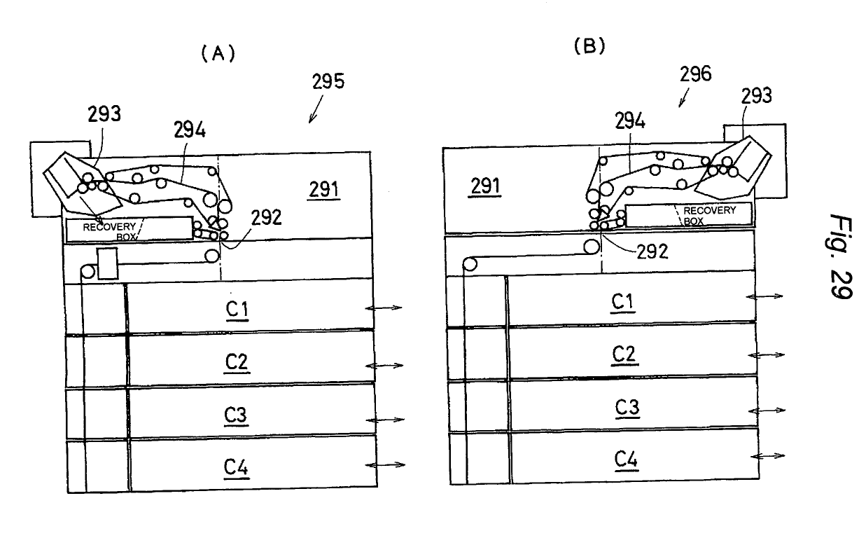

As shown in FIG. 29, the upper unit 291 has a bill reception port 292 for receiving bills, in the lower central part thereof for the purpose of common connection, and the bill reception port 292 and a fixed bucket 293 disposed at one end in the longitudinal direction of this upper unit are connected by an upper transfer path 294. When the upper unit 291 is inverted 180°, the apparatus can be changed-over, and it can be utilized as a rear maintenance machine 295 as shown in FIG. 29(A) or a front maintenance machine 296 as shown in FIG. 29(B).

In this case, the position of a bill take-out port 297 can be changed-over onto the front side of the apparatus or the rear side thereof merely by changing the mounting direction of the upper unit 291 to the amount of 180° in the horizontal direction. Also in this case, only the upper unit 291 is different, and the other constituents are the same, so that similar functional effects are attained.

As described above, in the case of the utilization as the front maintenance machine, the bill take-out port of the upper unit may be faced onto the front side of the apparatus being the maintenance side thereof, and in the case of the utilization as the rear maintenance machine, the bill take-out port of the upper unit may be faced onto the front side, the apparatus being handled for maintenance from its rear side. Therefore, either of both the machines can be selected merely by including the single traveling bucket utilizable in common, in the upper unit. Besides, a common spare unit of one kind suffices for component exchange. Therefore, both the machines can be coped with the same kind of spare unit as that of the traveling bucket, so that waste is eliminated in production and management to enhance a production control.

Regarding the corresponding relationships between this invention and the constructions of the foregoing embodiments,

the medium processing apparatus of this invention corresponds to the bill processing apparatus 11 of each embodiment, and

similarly,

media correspond to the bills A,

a medium reception opening corresponds to the reception opening 17a,

a medium ejection opening corresponds to the ejection opening 17b,

a medium reception position corresponds to the bill reception port 16,

a medium ejection position and a medium take-out port correspond to the bill take-out port 15,

reversible transportation means, and movement permitting means correspond to each of the upper units 12, 291, and the positioning protrusions 23 as well as the positioning recesses 24, respectively,

cartridges correspond to the first-fourth cartridges C1-C4,

a first medium take-out port corresponds to the bill take-out port 15 in the rear maintenance machine,

a second medium take-out port corresponds to the bill take-out port 15 in the front maintenance machine, and

recovery means corresponds to the mode changeover motor M2 as well as the CPU 101.

This invention shall be applicable on the basis of technical ideas defined in the claims and shall not be restricted only to the constructions of the foregoing embodiments.

According to this invention, a traveling bucket can be adapted to either a front maintenance machine or a rear maintenance machine by changing its sense to the amount of 180°, so that the common utilization of the traveling bucket can be attained.

### Industrial Applicability

This invention can be applied to cash dispensers and automated teller machines (ATMs) which are installed in banking organs.

1) a medium processing apparatus, comprising:
a traveling bucket which has a medium reception opening inside, and a medium ejection opening outside, and which travels from a medium reception position to a medium ejection position; and
reversible transportation means for allowing said traveling bucket to travel in a sense in one traveling direction or in a sense in the other traveling direction in which the first-mentioned sense of said bucket is reversed.

2) A medium processing apparatus where in a medium delivered from a cartridge is guided to an identification section and identified thereby, and the medium is guided to an external medium take-out port and subjected to an ejection operation when identified to be capable of being issued, comprising:
a traveling bucket which has a medium reception opening inside, and a medium ejection opening outside, and which travels from a medium reception position to a medium ejection position;
traveling rails which allow said traveling bucket to reversibly travel in one direction of receiving media or in the other direction of ejecting media, and which allow said traveling bucket to travel in a sense in one traveling direction or in a sense in the other traveling direction where the first-mentioned sense of said bucket is reversed;
a first medium take-out port to which the medium ejection opening of said traveling bucket corresponds in said one traveling direction of said bucket that travels on said traveling rails; and
a second medium take-out port to which said medium ejection opening of said traveling bucket corresponds in said other traveling direction of said bucket that travels on said traveling rails.

3) A medium processing apparatus as defined in claim 1 or 2, comprising recovery means for directly recovering any medium into a recovery box, when the medium delivered from a cartridge is guided to an identification section and identified to be incapable of being issued.

4) A medium processing apparatus as defined in any of claims 1-3, wherein directions of taking out cartridges and the recovery box which are attached so as to be taken out of said apparatus are set to be one direction of said apparatus.

5) A medium processing apparatus as defined in any of claims 1-4, wherein the recovery box includes a movable partition plate which defines an inner space of said recovery box into one portion and the other portion so as to separately recover media.

6) A medium processing apparatus wherein a medium delivered from a cartridge is guided to an identification section and identified thereby, and the medium is guided to an external medium take-out port and subjected to an ejection operation when identified to be capable of being issued, comprising:
an upper unit which has a medium reception port inside, the port receiving the medium identified by the identification section, and a medium ejection port outside; and
movement permitting means for locating the medium ejection port of said upper unit onto a front side or a rear side of said apparatus.
